(19) United States
(12) Patent Application Publication
(10) Pub. No.: US 2022/0237483 A1
(43) Pub. Date: Jul. 28, 2022

(54) SYSTEMS AND METHODS FOR APPLICATION ACCESSIBILITY TESTING WITH ASSISTIVE LEARNING

(71) Applicant: Capital One Services, LLC, McLean, VA (US)

(72) Inventors: Lara MOSSLER, Farmville, VA (US); Jayanth PRATHIPATI, Aldie, VA (US)

(21) Appl. No.: 17/159,803

(22) Filed: Jan. 27, 2021

(51) Int. Cl. G06N 5/04; G06N 20/00

(52) U.S. Cl. CPC G06N 5/04; G06N 20/00

(57) ABSTRACT

Systems and methods for an automated testing system may include a server including a processor and a memory. The memory may contain an accessibility matrix. The system may include a test engine in data communication with the server. The test engine may include a machine learning model. Upon receipt of a development application comprising one or more functions, the test engine may be configured to generate a test script configured to test at least one of the one or more functions, execute the test script to generate a test result, and implement a change to the development application based on the test result and the accessibility matrix.

### FIELD OF THE DISCLOSURE

The present disclosure relates to systems and methods for application accessibility testing with assistive learning.

### BACKGROUND

Accessibility testing of software applications presents challenges because applications may be configured to operate on various platforms. For example, a mobile application may be configured to execute on a mobile device with limited memory, a mobile operating system, and a touchscreen having a small screen size. As another example, a desktop application may be configured for execution on a desktop with a larger memory, desktop operating system, and a larger screen without touch screen capability. Depending upon a user's experience and proficiency with software applications and mobile and desktop devices, as well as a user's eyesight, hearing, and motor skills, software applications may be considered accessible or inaccessible for that user. Accessibility testing may help improve the accessibility of programs to a range of users.

Conventional accessibility testing may be further hindered because compliance regulations are mainly focused on the Internet and the World Wide Web. Further, accessibility testing may not take into account device features or provide mechanisms to correct or prioritize deficiencies in a manner consistent with a given framework. In many instances, accessibility is not given a high priority and is not considered in the same manner as other aspects of compliance.

These and other deficiencies exist. Accordingly, there is a need for systems and methods for improving the user interactive development experience, accounting for targeted mobile-based compliance, and allowing for implementation of preferred accessibility solutions for applications being tested.

### SUMMARY OF THE DISCLOSURE

Embodiments of the present disclosure provide an automated testing system. The automated testing system may include a server including a processor and a memory. The memory may contain an accessibility matrix. The system may include a test engine in data communication with the server. The test engine may include a machine learning model. Upon receipt of a development application comprising one or more functions, the test engine may be configured to generate a test script configured to test at least one of the one or more functions, execute the test script to generate a test result, and implement a change to the development application based on the test result and the accessibility matrix.

Embodiments of the present disclosure provide an automated testing method comprising providing a development application; generating, by a test engine, a test script, wherein the test engine comprises a machine learning model trained on a training dataset comprising a plurality of case studies; executing, by the test engine, the test script; generating, by the test script, a test result; identifying, by the test engine, a change to the development application by comparing the test result and accessibility matrix; and implementing, by the test engine, the change to the development application.

Embodiments of the present disclosure provide a non-transitory computer-accessible medium having stored thereon computer-executable instructions for automated testing, wherein, when a computer arrangement executes the instructions, the computer arrangement is configured to perform procedures comprising: training a test engine comprising a machine learning model on a plurality of case studies; generating a test script for a development application; executing the test script to generate a test result; comparing the test result to an accessibility matrix; identifying a change to the development application based on the comparison; assigning a score to the change; comparing the score to a threshold; and upon determining that the score exceeds the threshold, implementing the change to the development application.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts an automated testing system according to an exemplary embodiment.

FIG. 2 depicts a method of automated testing according to an exemplary embodiment.

FIG. 3 depicts a method of automated testing according to an exemplary embodiment.

FIG. 4 depicts a method of automated testing according to an exemplary embodiment.

FIG. 5 depicts an accessibility matrix according to an exemplary embodiment.

FIG. 6A depicts a graphical user interface according to an exemplary embodiment.

FIG. 6B depicts a graphical user interface according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Benefits of the systems and methods disclosed herein include providing a result that assesses how applications are doing with respect to accessibility along with where and how they may improve. Moreover, the systems and methods disclosed herein provide an improvement over existing implementations by taking into account native mobile applications as well as applications built for desktop and laptop computers. Native mobile applications are often built-in device features which are different than devices using the web, such as desktops or laptops. The automated testing framework applying accessibility standards described herein may be implemented as a guide to classifying and triggering certain actions based on test result and an accessibility matrix prior to implementation of the change to a development application. In this manner, features associated with, including but not limited to a camera or Global Positioning System (GPS) of a device, may be used that are not covered by existing web-based compliance standards, which improves the user interactive development experience, accounts for targeted mobile-based compliance, and allows for implementation of preferred accessibility solutions for applications being tested.

Systems and methods disclosed herein may perform accessibility testing to improve user outcomes. Users may face a variety of obstacles to efficient and effective interactions with software applications, including without limitation, lack of familiarity with the application and lack of familiarity with the desktop computer, mobile device, wearable device, or other device on which the software application is executing. The automated testing framework described herein may apply wide-ranging accessibility considerations to improve interactions for such users.

Systems and methods disclosed herein may help outcomes from users experiencing disabilities. For example, users that suffer from a lack of eyesight, a lack of hearing, and/or a lack of motor skills may find it difficult to successfully interact with devices and software applications. The automated testing framework described herein may identify deficiencies and areas for improvements, and recommend and/or implement improvements that may benefit users with disabilities. Further, as users may experience a range of disabilities that impact their interactions with devices and software applications in variety of ways, and the automated testing framework may accommodate users across a range of improvements.

Systems and methods disclosed herein include automated testing frameworks with test engines utilizing machine learning models to identify deficiencies, recommend corrections, and in some instances, implement corrections. The machine learning models may be trained on case studies relating to accessibility, which may include, without limitation, applications having at least one selected from the group of one or more accessibility deficiencies, one or more accessibility corrections, results from one or more prior accessibility tests, and one or more previously-tested applications that reflect corrections made due to accessibility testing, and/or any combination thereof. Training the models using case studies may advantageously capture accessibility considerations, corrections, and improvements that may be difficult to identify from conventional accessibility guidelines and for which corrections may be difficult to effectively implement based on conventional accessibility guidelines.

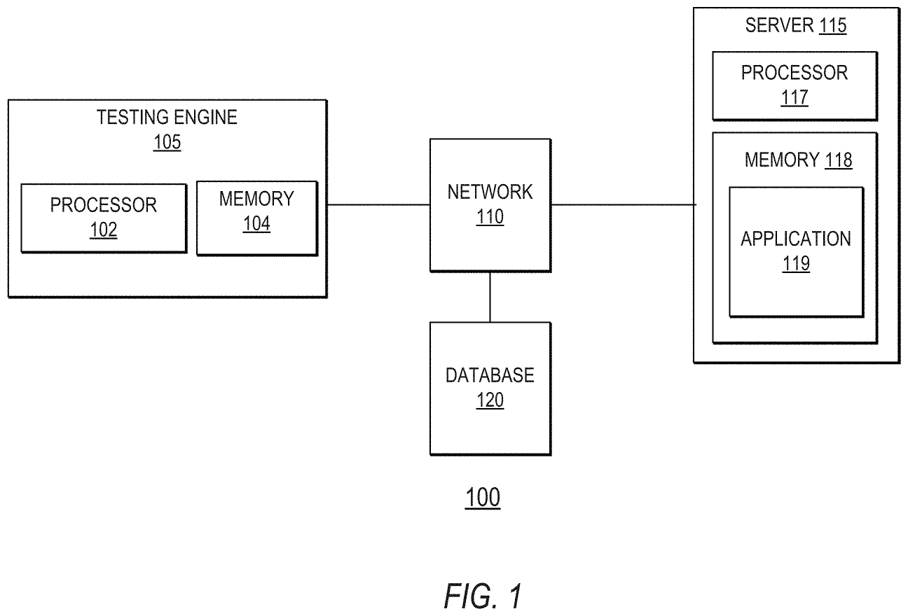

FIG. 1 illustrates an automated testing system 100. The system 100 may comprise a test engine 105, a network 110, a server 115, and a database 120. Although FIG. 1 illustrates single instances of components of system 100, system 100 may include any number of components.

System 100 may include a test engine 105. Test engine 105 may include one or more processors 102, and memory 104. Test engine 105 may comprise a machine learning model. Test engine 105 may be in data communication with any number of components of system 100. For example, test engine 105 may transmit data via network 110 to a server 115. Test engine 105 may transmit data via network 110 to database 105.

Without limitation, test engine 105 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. Test engine 105 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Test engine 105 may include processing circuitry and may contain additional components, including processors, memories, error and parity/CRC checkers, data encoders, anticollision algorithms, controllers, command decoders, security primitives and tamperproofing hardware, as necessary to perform the functions described herein. The test engine 105 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include a network 110. In some examples, network 110 may be one or more of a wireless network, a wired network or any combination of wireless network and wired network, and may be configured to connect to any one of components of system 100. For example, test engine 105 may be configured to connect to server 115 via network 110. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may include one or more servers 115. In some examples, server 115 may include one or more processors 117 coupled to memory 118. Server 115 may be configured as a central system, server or platform to control and call various data at different times to execute a plurality of workflow actions. Server 115 may be configured to connect to test engine 105. Server 115 may be in data communication with any number of components of system 100. Test engine 105 may be in communication with one or more servers 115 via one or more networks 110, and may operate as a respective front-end to back-end pair with server 115. Test engine 105 may transmit one or more requests to server 115. The one or more requests may be associated with retrieving data from server 115. Server 115 may receive the one or more requests from test engine 105. Based on the one or more requests from test engine 105, server 115 may be configured to retrieve the requested data. Server 115 may be configured to transmit the received data to test engine 105, the received data being responsive to one or more requests.

In some examples, server 115 may be a dedicated server computer, such as bladed servers, or may be personal computers, laptop computers, notebook computers, palm top computers, network computers, mobile devices, wearable devices, or any processor-controlled device capable of supporting the system 100. While FIG. 1 illustrates a single server 115, it is understood that other embodiments may use multiple servers or multiple computer systems as necessary or desired to support the users and may also use back-up or redundant servers to prevent network downtime in the event of a failure of a particular server.

Server 115 may include an application 119 comprising instructions for execution thereon. For example, the application 119 may comprise instructions for execution on the server 115. The application may be in communication with any components of system 100. For example, server 115 may execute one or more applications 119 that enable, for example, network and/or data communications with one or more components of system 100 and transmit and/or receive data. Without limitation, server 115 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. Server 115 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 115 may include processing circuitry and may contain additional components, including processors, memories, error and parity/CRC checkers, data encoders, anticollision algorithms, controllers, command decoders, security primitives and tamperproofing hardware, as necessary to perform the functions described herein. The server 115 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 120. The database 120 may comprise a relational database, a non-relational database, or other database implementations, and any combination thereof, including a plurality of relational databases and non-relational databases. In some examples, the database 120 may comprise a desktop database, a mobile database, or an in-memory database. Further, the database 120 may be hosted internally by any component of system 100, such as the test engine 105 or server 115, or the database 120 may be hosted externally to any component of the system 100, such as the test engine 105 or server 115, by a cloud-based platform, or in any storage device that is in data communication with the test engine 105 and server 115. In some examples, database 120 may be in data communication with any number of components of system 100. For example, server 115 may be configured to retrieve the requested data from the database 120 that is transmitted by test engine 105. Server 115 may be configured to transmit the received data from database 120 to test engine 105 via network 110, the received data being responsive to the transmitted one or more requests. In other examples, test engine 105 may be configured to transmit one or more requests for the requested data from database 120 via network 110.

In some examples, exemplary procedures in accordance with the present disclosure described herein may be performed by a processing arrangement and/or a computing arrangement (e.g., computer hardware arrangement). Such processing/computing arrangement may be, for example entirely or a part of, or include, but not limited to, a computer/processor that may include, for example one or more microprocessors, and use instructions stored on a computer-accessible medium (e.g., RAM, ROM, hard drive, or other storage device). For example, a computer-accessible medium may be part of the memory of the test engine 105, server 115, and/or database 120, or other computer hardware arrangement.

In some examples, a computer-accessible medium (e.g., as described herein above, a storage device such as a hard disk, floppy disk, memory stick, CD-ROM, RAM, ROM, etc., or a collection thereof) may be provided (e.g., in communication with the processing arrangement). The computer-accessible medium may contain executable instructions thereon. In addition or alternatively, a storage arrangement may be provided separately from the computer-accessible medium, which may provide the instructions to the processing arrangement so as to configure the processing arrangement to execute certain exemplary procedures, processes, and methods, as described herein above, for example.

The memory 117 may comprise a matrix, such as an accessibility matrix. The memory 117 may contain a library. In some examples, the library may be configured to provide one or more interfaces. For example, the library may be configured to provide an accessibility matrix interface. The library may be further configured to provide an evaluation report interface.

The test engine 105 may be in data communication with the server 115. The test engine 105 may comprise a machine learning model. The machine learning model may be trained on a dataset comprising a plurality of case studies. In an embodiment, the machine learning algorithm employed may include at least one selected from the group of gradient boosting machine, logistic regression, neural networks, and/or any combination thereof, however, it is understood that other machine learning algorithms may be utilized. The machine learning model may be trained to recognize one or more faults in a development application. For example, the development application may comprise instructions for execution on a device. Without limitation, the one or more faults in the development may include insufficiently addressing accessibility deficiencies, and where the development application is not meeting or complying with all requirements of the framework. In some examples, the plurality of case studies may comprise case study applications including at least one selected from the group of one or more accessibility deficiencies, one or more accessibility corrections, results from one or more prior accessibility tests, and one or more previously-tested applications that reflect corrections made due to accessibility testing, and/or any combination thereof. In some examples, the plurality of case studies may comprise case study applications that comply with the accessibility matrix. In some examples, the one or more accessibility deficiencies may comply with the accessibility matrix. In other examples, the one or more accessibility corrections may comply with the accessibility matrix. In yet other examples, the one or more accessibility deficiencies and the one or more accessibility corrections may comply with the accessibility matrix.

In some examples, the test engine 105 may utilize machine learning to generate one or more machine learning models. The exemplary machine learning may utilize information from case studies, previous accessibility testing, and other data sources to generate models. The test engine may then apply the generated models to identify to create scripts and to identify areas for accessibility testing and accessibility deficiencies contained therein.

The test engine 105 may utilize various neural networks, such as convolutional neural networks (“CNN”) or recurrent neural networks (“RNN”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real-valued weight. Nodes may either be (i) input nodes (e.g., receiving data from outside the network), (ii) output nodes (e.g., yielding results), or (iii) hidden nodes (e.g., that may modify the data en route from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The test engine 105 may be configured to receive one or more applications, such as the development application. For example, the test engine 105 may be configured to, upon receipt of a development application comprising one or more functions, generate one or more scripts. In some examples, the script may include a test script. The script may be generated and associated with one or more features, such as pushing a desired button or buttons, input entry into one or more fields, push out an alert of the accessibility matrix, and/or any combination or sequence thereof. For example, the test script may be configured to test at least one of the one or more functions of the development application. The test engine 105 may be configured to execute the test script to generate a test result. The test engine 105 may be configured to implement one or more changes based on test result. For example, the test engine 105 may be configured to implement one or more changes to the development application based on the test result and the accessibility matrix.

In some examples, prior to implementation of the one or more changes to the development application, the test engine 105 may be configured to identify the change by comparing the test result to the accessibility matrix. The test engine 105 may be configured to classify the change in one or more categories. For example, the test engine 105 may be configured to classify the change in at least one selected from the group of an appearance change category, a functionality change category, and/or any combination thereof. In some examples, the test engine 105 may be configured to, upon classifying the change in the functionality change category, request approval to process the change. For example, the test engine 105 may be configured to request user approval prior to implementing the change.

In some examples, the appearance change category may comprise at least one selected from the group of a font size change, a font color change, a color contrast change, and/or any combination thereof. In some examples, the appearance change may be selected to address a type of color blindness.

In some examples, the functionality change category may comprise at least one selected from the group of adding one or more user interface elements, removing one or more user interface elements, increasing a spacing between a plurality of user interface elements, decreasing a spacing between a plurality of user interface elements, adding a feedback, removing a feedback, and/or any combination thereof. In some examples, the feedback may comprise at least one selected from the group of a visual notification, an audio notification, an animation notification, a haptic notification, and/or any combination thereof. Exemplary user interface elements may include, without limitation, widgets, windows, window borders, buttons, icons, menus, tabs, scroll bars, zooming tools, dialog boxes, check boxes, radio buttons, hyperlinks, and text.

In some examples, prior to implementation of the one or more changes to the development application, the test engine 105 may be configured to classify the one or more changes as a type of impact change. For example, the test engine 105 may be configured to classify the one or more changes as a high impact change. In another example, the test engine 105 may be configured to classify the one or more changes as a low impact change. In yet another example, the test engine 105 may be configured to classify the one or more changes as a high impact change, a low impact change, and/or any combination thereof. In some examples, the test engine 105 may be configured to implement the change upon determining that the change is a low impact change. In some examples, the test engine 105 may be configured to implement the change upon determining that the change is a high impact change, transmit one or more requests for approval prior to implementation of the change. For example, the test engine 105 may be configured to upon determining that the change is a high impact change, transmit a request for user approval prior to implementing the change.

Without limitation, the one or more accessibility deficiencies may include one or more disabilities, for example visual impairments such as nearsightedness and/or color blindness. Without limitation, the one or more accessibility corrections may include one or more features to fix or correct the accessibility shortcoming or deficiency. For example, this may include correcting the accessibility deficiency associated with a caption for an icon that is in a font that is too small for a nearsighted user. In another example, this may include correcting the accessibility deficiency associated with a caption for an icon that is in a color that does not work for certain types of colorblindness, such as green text for a red/green colorblindness user. In another example, this may include correcting the accessibility deficiency associated with amplifying the sound of a notification for an error message for a hearing-limited user. In another example, this may include correcting the accessibility deficiency associated with requesting alternative haptic input or feedback if the initially requested haptic input or feedback is insufficient or inapplicable for a user having physical disabilities. In this example, this may comprise requesting hand palm pressing instead of fingerprint pressing. In another example, this may include correcting the accessibility deficiency associated with requesting audible haptic input or alternative haptic input associated with Braille for a blind user attempting to provide a credit card number, name, expiration date, and/or card verification value.

Alternatively or additionally, the test engine 105 may be configured to generate and provide one or more suggestions, such as a prediction or recommendation, for correcting the one or more accessibility deficiencies. The high or low impact change may be restricted to recommendations, but the latter high or low impact change may be permitted for implementation instead of recommendations.

In another example, the test engine 105 may be configured to implement one or more changes to the development application within desired functions or desired areas of changes. For example, the font size and/or color may be sufficient but rearrangement of the icons may be restricted to recommendations, such as missing using animations on error messages. Alternatively or additionally, the one or more changes to legacy features of the native mobile application may be proper for the test engine 105 to change whereas new features of the native mobile application and/or authorized access, such as developers associated with the native mobile application, may desire more or less control of the new features of the native mobile application.

The test engine 105 may be configured to assign a score to the change. For example, the test engine 105 may be configured to compare the score to a predetermined threshold. The test engine 105 may be configured to implement the change if the score exceeds the predetermined threshold and request review and approval of the change is the score does not exceed the predetermined threshold. In some examples, the score may include at least one selected from the group of characters, numbers, symbols, images, and/or any combination thereof. In some examples, the threshold may be dynamic, in that the test engine 105 may generate the threshold dynamically for each development application.

As an illustrative example, a development application may comprise an application or website for booking a hotel. In this example, the test engine 105 may be configured to launch the development application, click on a search function, search for rooms available at hotels in the Washington, D.C. area, select June 1-2 as booking dates, and book these dates. In this example, the testing would check, prior to identifying and/or implementing the one or more changes based on comparison of a test script generated test result and the accessibility matrix, how the visual presentation of this information occurred (including but not limited to color contrast, button click, search fields, input entries, scroll menus, confirmation lists, check boxes, radio buttons), any type of received haptic feedback, and any type of audible indicators that may have been generated. While the foregoing is an illustrative example, it is understood that the development application may be any application used for any purpose.

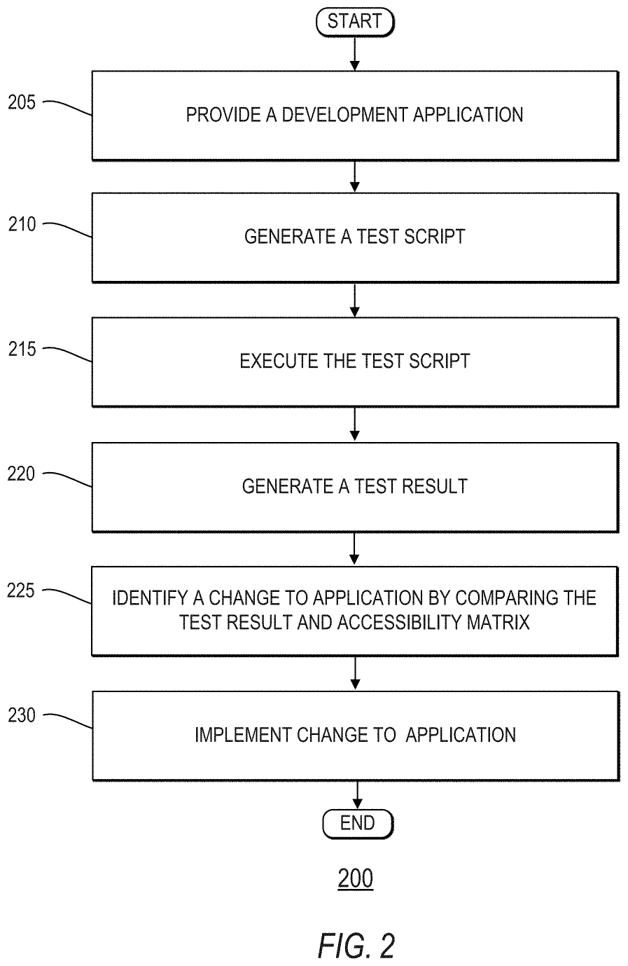

FIG. 2 depicts a method 200 of automated testing. FIG. 2 may reference the same or similar components of system 100.

At block 205, the method 200 may comprise providing a development application. For example, the development application may comprise instructions for execution on a device.

At block 210, the method 200 may comprise generating, by a test engine, a test script. For example, the test engine may be configured to receive one or more applications, such as the development application. For example, the test engine may be configured to, upon receipt of a development application comprising one or more functions, generate one or more scripts. In some examples, the script may include a test script. The script may be generated and associated with one or more features, such as pushing a desired button or buttons, input entry into one or more fields, push out an alert of an accessibility matrix, and/or any combination or sequence thereof.

At block 215, the method 200 may comprise executing the test script. For example, the test script may be configured to test at least one of the one or more functions of the development application.

At block 220, the method 200 may comprise generating a test result. For example, the test engine may be configured to execute the test script to generate a test result.

At block 225, the method 200 may comprise identifying a change to the development application by comparing the test result and the accessibility matrix. The memory may comprise a matrix, such as an accessibility matrix. For example, the test engine may be in data communication with one or more servers. The one or more servers may comprise a processor and a memory including one or more applications comprising instructions for execution on the one or more servers. The memory may also include a library. In some examples, the library may be configured to provide one or more interfaces. For example, the library may be configured to provide an accessibility matrix interface. The library may be further configured to provide an evaluation report interface.

In some examples, one or more servers may include one or more processors coupled to memory. The one or more servers may be configured as a central system, server or platform to control and call various data at different times to execute a plurality of workflow actions. The one or more servers may be configured to connect to the test engine via one or more networks. The one or more servers may be in data communication with any number of components of the system. The test engine may be in communication with the one or more servers via the one or more networks, and may operate as a respective front-end to back-end pair with one or more servers. The test engine may transmit one or more requests to the one or more servers. The one or more requests may be associated with retrieving data from the one or more servers. The one or more servers may receive the one or more requests from the test engine. Based on the one or more requests from the test engine, the one or more servers may be configured to retrieve the requested data. The one or more servers may be configured to transmit the received data to the test engine, the received data being responsive to one or more requests.

In some examples, the one or more servers may be a dedicated server computer, such as bladed servers, or may be personal computers, laptop computers, notebook computers, palm top computers, network computers, mobile devices, wearable devices, or any processor-controlled device capable of supporting the system. While a single server may be used, it is understood that other embodiments may use multiple servers or multiple computer systems as necessary or desired to support the users and may also use back-up or redundant servers to prevent network downtime in the event of a failure of a particular server.

The one or more servers may include an application comprising instructions for execution thereon. For example, the application may comprise instructions for execution on the one or more servers. The application may be in communication with any components of the system. For example, one or more servers may execute one or more applications that enable, for example, network and/or data communications with one or more components of the system and transmit and/or receive data. Without limitation, one or more servers may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The one or more servers also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The one or more servers may include processing circuitry and may contain additional components, including processors, memories, error and parity/CRC checkers, data encoders, anticollision algorithms, controllers, command decoders, security primitives and tamperproofing hardware, as necessary to perform the functions described herein. The one or more servers may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, the one or more networks may be one or more of a wireless network, a wired network or any combination of wireless network and wired network, and may be configured to connect to any one of components of the system. For example, the test engine may be configured to connect to one or more servers via one or more networks. In some examples, the one or more networks may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the one or more networks may include, without limitation, telephone lines, fiber optics, IEEE Ethernet 902.3, a wide area network, a wireless personal area network, a LAN, or a global network such as the Internet. In addition, the one or more networks may support an Internet network, a wireless communication network, a cellular network, or the like, or any combination thereof. The one or more networks may further include one network, or any number of the exemplary types of networks mentioned above, operating as a stand-alone network or in cooperation with each other. The one or more networks may utilize one or more protocols of one or more network elements to which they are communicatively coupled. The one or more networks may translate to or from other protocols to one or more protocols of network devices. Although the one or more networks may be depicted as a single network, it should be appreciated that according to one or more examples, the one or more networks may comprise a plurality of interconnected networks, such as, for example, the Internet, a service provider's network, a cable television network, corporate networks, such as credit card association networks, and home networks.

The test engine may be in data communication with the one or more servers. The test engine may comprise a machine learning model. The machine learning model may be trained on a dataset comprising a plurality of case studies. In an embodiment, the machine learning algorithm employed may include at least one selected from the group of gradient boosting machine, logistic regression, neural networks, and/or any combination thereof, however, it is understood that other machine learning algorithms may be utilized. The machine learning model may be trained to recognize one or more faults in a development application. Without limitation, the one or more faults in the development may include insufficiently addressing accessibility deficiencies, and where the development application is not meeting or complying with all requirements of the framework. In some examples, the plurality of case studies may comprise case study applications including at least one selected from the group of one or more accessibility deficiencies, one or more accessibility corrections, results from one or more prior accessibility tests, and one or more previously-tested applications that reflect corrections made due to accessibility testing, and/or any combination thereof. In some examples, the plurality of case studies may comprise case study applications that comply with the accessibility matrix. In some examples, the one or more accessibility deficiencies may comply with the accessibility matrix. In other examples, the one or more accessibility corrections may comply with the accessibility matrix. In yet other examples, the one or more accessibility deficiencies and the one or more accessibility corrections may comply with the accessibility matrix.

At block 230, the method 200 may comprise implementing the change to the development application. For example, the test engine may be configured to implement one or more changes based on test result. For example, the test engine may be configured to implement one or more changes to the development application based on the test result and the accessibility matrix.

In some examples, prior to implementation of the one or more changes to the development application, the test engine may be configured to identify the change by comparing the test result to the accessibility matrix. The test engine may be configured to classify the change in one or more categories. For example, the test engine may be configured to classify the change in at least one selected from the group of an appearance change category, a functionality change category, and/or any combination thereof. In some examples, the test engine may be configured to, upon classifying the change in the functionality change category, request approval to process the change. For example, the test engine may be configured to request user approval prior to implementing the change.

In some examples, the appearance change category may comprise at least one selected from the group of a font size change, a font color change, a color contrast change, and/or any combination thereof. In some examples, the appearance change may be selected to address a type of color blindness.

In some examples, the functionality change category may comprise at least one selected from the group of adding one or more user interface elements, removing one or more user interface elements, increasing a spacing between a plurality of user interface elements, decreasing a spacing between a plurality of user interface elements, adding a feedback, removing a feedback, and/or any combination thereof. In some examples, the feedback may comprise at least one selected from the group of a visual notification, an audio notification, an animation notification, a haptic notification, and/or any combination thereof. Exemplary user interface elements may include, without limitation, widgets, windows, window borders, buttons, icons, menus, tabs, scroll bars, zooming tools, dialog boxes, check boxes, radio buttons, hyperlinks, and text.

In some examples, prior to implementation of the one or more changes to the development application, the test engine may be configured to classify the one or more changes as a type of impact change. For example, the test engine may be configured to classify the one or more changes as a high impact change. In another example, the test engine may be configured to classify the one or more changes as a low impact change. In yet another example, the test engine may be configured to classify the one or more changes as a high impact change, a low impact change, and/or any combination thereof. In some examples, the test engine may be configured to implement the change upon determining that the change is a low impact change. In some examples, the test engine may be configured to implement the change upon determining that the change is a high impact change, transmit one or more requests for approval prior to implementation of the change. For example, the test engine may be configured to upon determining that the change is a high impact change, transmit a request for user approval prior to implementing the change.

Without limitation, the one or more accessibility deficiencies may include one or more disabilities, for example visual impairments such as nearsightedness and/or color blindness. Without limitation, the one or more accessibility corrections may include one or more features to fix or correct the accessibility shortcoming or deficiency. For example, this may include correcting the accessibility deficiency associated with a caption for an icon that is in a font that is too small for a nearsighted user. In another example, this may include correcting the accessibility deficiency associated with a caption for an icon that is in a color that does not work for certain types of colorblindness, such as green text for a red/green colorblindness user. In another example, this may include correcting the accessibility deficiency associated with amplifying the sound of a notification for an error message for a hearing-limited user. In another example, this may include correcting the accessibility deficiency associated with requesting alternative haptic input or feedback if the initially requested haptic input or feedback is insufficient or inapplicable for a user having physical disabilities. In this example, this may comprise requesting hand palm pressing instead of fingerprint pressing. In another example, this may include correcting the accessibility deficiency associated with requesting audible haptic input or alternative haptic input associated with Braille for a blind user attempting to provide a credit card number, name, expiration date, and/or card verification value.

Alternatively or additionally, the test engine may be configured to generate and provide one or more suggestions, such as a prediction or recommendation, for correcting the one or more accessibility deficiencies. The high or low impact change may be restricted to recommendations, but the latter high or low impact change may be permitted for implementation instead of recommendations.

In another example, the test engine may be configured to implement one or more changes to the development application within desired functions or desired areas of changes. For example, the font size and/or color may be sufficient but rearrangement of the icons may be restricted to recommendations, such as missing using animations on error messages. Alternatively or additionally, the one or more changes to legacy features of the native mobile application may be proper for the test engine to change whereas new features of the native mobile application and/or authorized access, such as developers associated with the native mobile application, may desire more or less control of the new features of the native mobile application.

The test engine may be configured to assign a score to the change. For example, the test engine may be configured to compare the score to a predetermined threshold. The test engine may be configured to implement the change if the score exceeds the predetermined threshold. In some examples, the score may include at least one selected from the group of characters, numbers, symbols, images, and/or any combination thereof. In some examples, the threshold may be dynamic, in that the test engine 105 may generate the threshold dynamically for each development application.

As an illustrative example, test engine may be configured to launch the development application, click on the search function, search for rooms available in a venue in Washington, D.C., select June 1-2 as booking dates, and book these dates. In this example, the testing would check, prior to identifying the one or more changes based on comparison of a test script generated test result and the accessibility matrix, how the visual presentation of this information occurred (including but not limited to color contrast, button click, search fields, input entries, scroll menus, confirmation lists, check boxes, radio buttons), any type of received haptic feedback, and any type of audible indicators that may have been generated.

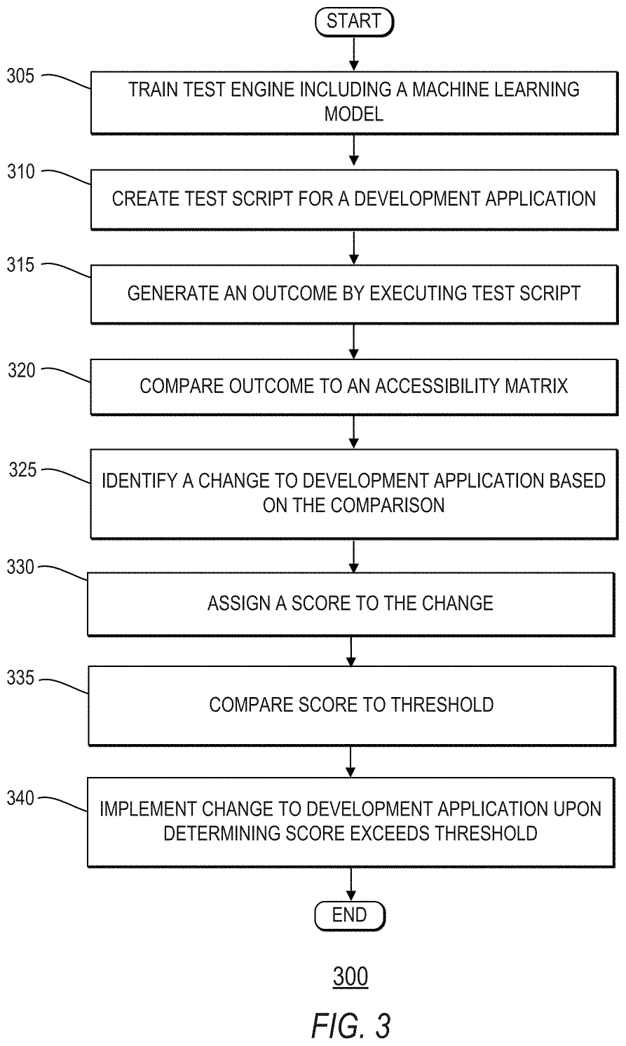

FIG. 3 depicts a method 300 for automated testing according to an exemplary embodiment. FIG. 3 may reference the same or similar components of system 100 and method 200.

At block 305, the method 300 may include training a test engine comprising a machine learning model on a plurality of case studies. The test engine may comprise a machine learning model. The machine learning model may be trained on a dataset comprising a plurality of case studies. In an embodiment, the machine learning algorithm employed may include at least one selected from the group of gradient boosting machine, logistic regression, neural networks, and/or any combination thereof, however, it is understood that other machine learning algorithms may be utilized. The machine learning model may be trained to recognize one or more faults in a development application. Without limitation, the one or more faults in the development may include insufficiently addressing accessibility deficiencies, and where the development application is not meeting or complying with all requirements of the framework. In some examples, the plurality of case studies may comprise case study applications including at least one selected from the group of one or more accessibility deficiencies, one or more accessibility corrections, results from one or more prior accessibility tests, and one or more previously-tested applications that reflect corrections made due to accessibility testing, and/or any combination thereof. In some examples, the plurality of case studies may comprise case study applications that comply with an accessibility matrix. In some examples, the one or more accessibility deficiencies may comply with the accessibility matrix. In other examples, the one or more accessibility corrections may comply with the accessibility matrix. In yet other examples, the one or more accessibility deficiencies and the one or more accessibility corrections may comply with the accessibility matrix.

At block 310, the method 300 may include creating a test script for a development application. For example, the test engine may be configured to receive one or more applications, such as a development application. The development application may comprise instructions for execution on a device. For example, the test engine may be configured to, upon receipt of a development application comprising one or more functions, generate one or more scripts. In some examples, the script may include a test script. The script may be generated and associated with one or more features, such as pushing a desired button or buttons, input entry into one or more fields, push out an alert of an accessibility matrix, and/or any combination or sequence thereof.

At block 315, the method 300 may include generating an outcome by executing the test script. For example, the outcome may comprise a test result as a result of the execution of the test script. The test script may be configured to test at least one of the one or more functions of the development application.

At block 320, the method 300 may include comparing the outcome to an accessibility matrix. For example, the test engine may be configured to compare the test result to an accessibility matrix. The memory of a server, that is in data communication with the test engine, may comprise a matrix, such as an accessibility matrix. For example, the test engine may be in data communication with one or more servers. The one or more servers may comprise a processor and a memory including one or more applications comprising instructions for execution on the one or more servers. The memory may also include a library. In some examples, the library may be configured to provide one or more interfaces. For example, the library may be configured to provide an accessibility matrix interface. The library may be further configured to provide an evaluation report interface.

At block 325, the method 300 may include identifying a change to the development application based on the comparison. For example, the test engine may be configured to identify one or more changes to the development application based on the comparison between the test result to the accessibility matrix. The test engine may be configured to classify the change in one or more categories. For example, the test engine may be configured to classify the change in at least one selected from the group of an appearance change category, a functionality change category, and/or any combination thereof. In some examples, the test engine may be configured to, upon classifying the change in the functionality change category, request approval to process the change. For example, the test engine may be configured to request user approval prior to implementing the change.

In some examples, the appearance change category may comprise at least one selected from the group of a font size change, a font color change, a color contrast change, and/or any combination thereof. In some examples, the appearance change may be selected to address a type of color blindness.

In some examples, the functionality change category may comprise at least one selected from the group of adding one or more user interface elements, removing one or more user interface elements, increasing a spacing between a plurality of user interface elements, decreasing a spacing between a plurality of user interface elements, adding a feedback, removing a feedback, and/or any combination thereof. In some examples, the feedback may comprise at least one selected from the group of a visual notification, an audio notification, an animation notification, a haptic notification, and/or any combination thereof. Exemplary user interface elements may include, without limitation, widgets, windows, window borders, buttons, icons, menus, tabs, scroll bars, zooming tools, dialog boxes, check boxes, radio buttons, hyperlinks, and text.

At block 330, the method 300 may include assigning a score to the change. The test engine may be configured to assign a score to the change. In some examples, the test engine may be configured to assign one or more scores to one or more changes. In some examples, the test engine may be configured to rank the one or more assigned scores corresponding to the one or more changes.

At block 335, the method 300 may include comparing the score to a threshold. For example, the test engine may be configured to compare the score to a predetermined threshold. The test engine may be configured to implement the change if the score exceeds the predetermined threshold. In some examples, the score may include at least one selected from the group of characters, numbers, symbols, images, and/or any combination thereof. Similarly, the predetermined threshold may include at least one selected from the group of characters, numbers, symbols, images, and/or any combination thereof. In some examples, the test engine may be configured to compare each of the assigned and/or ranked one or more scores to one or more respective predetermined thresholds before deciding to implement one or more changes to the development application.

At block 340, the method 300 may include upon determining that the score exceeds the threshold, implementing the change to the development application. For example, the test engine may be configured to implement one or more changes to the development application upon a determination that the score exceeds a predetermined threshold. In some examples, the test engine may be configured to implement one or more changes to the development application upon determination that each of the assigned and/or ranked one or more scores exceed one or more respective predetermined thresholds before deciding to implement one or more changes to the development application.

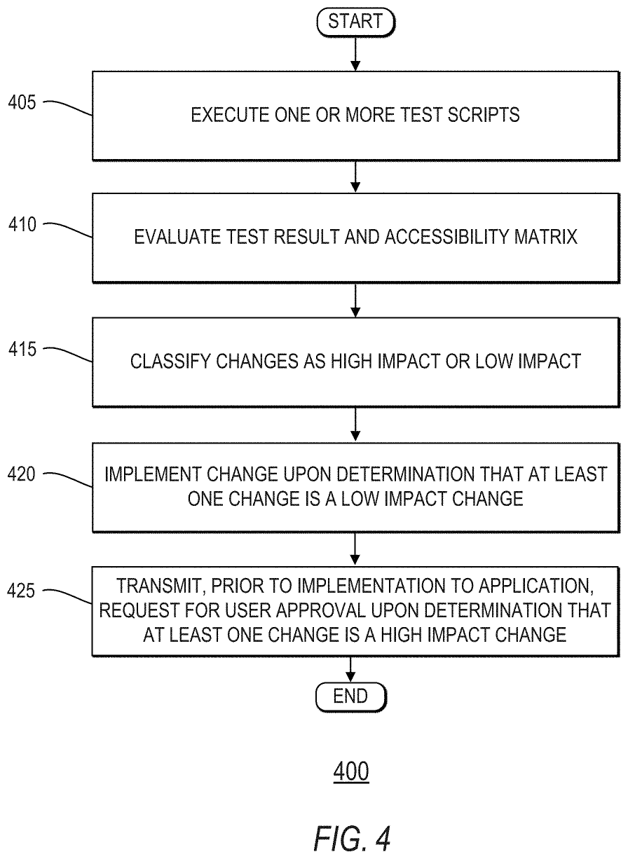

FIG. 4 depicts a method 400 for automated testing according to an exemplary embodiment. FIG. 4 may reference the same or similar components of system 100, method 200, and method 300.

At block 405, the method 400 may include executing one or more test scripts. For example, the test engine may comprise a machine learning model. The machine learning model may be trained on a dataset comprising a plurality of case studies. In an embodiment, the machine learning algorithm employed may include at least one selected from the group of gradient boosting machine, logistic regression, neural networks, and/or any combination thereof, however, it is understood that other machine learning algorithms may be utilized. The machine learning model may be trained to recognize one or more faults in a development application. Without limitation, the one or more faults in the development may include insufficiently addressing accessibility deficiencies, and where the development application is not meeting or complying with all requirements of the framework. In some examples, the plurality of case studies may comprise case study applications including at least one selected from the group of one or more accessibility deficiencies, one or more accessibility corrections, results from one or more prior accessibility tests, and one or more previously-tested applications that reflect corrections made due to accessibility testing, and/or any combination thereof. In some examples, the plurality of case studies may comprise case study applications that comply with an accessibility matrix. In some examples, the one or more accessibility deficiencies may comply with the accessibility matrix. In other examples, the one or more accessibility corrections may comply with the accessibility matrix. In yet other examples, the one or more accessibility deficiencies and the one or more accessibility corrections may comply with the accessibility matrix.

In some examples, the test engine may be configured to receive one or more applications, such as a development application. The development application may comprise instructions for execution on a device. For example, the test engine may be configured to, upon receipt of a development application comprising one or more functions, generate one or more scripts. In some examples, the script may include a test script. The script may be generated and associated with one or more features, such as pushing a desired button or buttons, input entry into one or more fields, push out an alert of an accessibility matrix, and/or any combination or sequence thereof.

At block 410, the method 400 may include evaluating a test result and the accessibility matrix. For example, the evaluation may include a generated outcome that may comprise a test result as a result of the execution of the test script. The test script may be configured to test at least one of the one or more functions of the development application. In particular, the evaluation may include comparing the outcome to an accessibility matrix. For example, the test engine may be configured to compare the test result to an accessibility matrix. The memory of a server, that is in data communication with the test engine, may comprise a matrix, such as an accessibility matrix. For example, the test engine may be in data communication with one or more servers. The one or more servers may comprise a processor and a memory including one or more applications comprising instructions for execution on the one or more servers. The memory may also include a library. In some examples, the library may be configured to provide one or more interfaces. For example, the library may be configured to provide an accessibility matrix interface. The library may be further configured to provide an evaluation report interface.

At block 415, the method 400 may include classifying the change as a high impact change or a low impact change. The test engine may be configured to identify a change to the development application based on the evaluation. For example, the test engine may be configured to identify one or more changes to the development application based on the comparison between the test result to the accessibility matrix. The test engine may be configured to classify the change in one or more categories. For example, the test engine may be configured to classify the change in at least one selected from the group of an appearance change category, a functionality change category, and/or any combination thereof. In some examples, the test engine may be configured to, upon classifying the change in the functionality change category, request approval to process the change. For example, the test engine may be configured to request user approval prior to implementing the change.

In some examples, the appearance change category may comprise at least one selected from the group of a font size change, a font color change, a color contrast change, and/or any combination thereof. In some examples, the appearance change may be selected to address a type of color blindness.

In some examples, the functionality change category may comprise at least one selected from the group of adding one or more user interface elements, removing one or more user interface elements, increasing a spacing between a plurality of user interface elements, decreasing a spacing between a plurality of user interface elements, adding a feedback, removing a feedback, and/or any combination thereof. In some examples, the feedback may comprise at least one selected from the group of a visual notification, an audio notification, an animation notification, a haptic notification, and/or any combination thereof. Exemplary user interface elements may include, without limitation, widgets, windows, window borders, buttons, icons, menus, tabs, scroll bars, zooming tools, dialog boxes, check boxes, radio buttons, hyperlinks, and text.

At block 420, the method 400 may include implementing the change upon determining that the change is a low impact change. In some examples, prior to implementation of the one or more changes to the development application, the test engine may be configured to classify the one or more changes as a type of impact change. For example, the test engine may be configured to classify the one or more changes as a high impact change. In another example, the test engine may be configured to classify the one or more changes as a low impact change. In yet another example, the test engine may be configured to classify the one or more changes as a high impact change, a low impact change, and/or any combination thereof. In some examples, the test engine may be configured to implement the change upon determining that the change is a low impact change. In some examples, the test engine may be configured to implement the change upon determining that the change is a high impact change, transmit one or more requests for approval prior to implementation of the change. For example, the test engine may be configured to upon determining that the change is a high impact change, transmit a request for user approval prior to implementing the change.

Without limitation, the one or more accessibility deficiencies may include one or more disabilities, for example visual impairments such as nearsightedness and/or color blindness. Without limitation, the one or more accessibility corrections may include one or more features to fix or correct the accessibility shortcoming or deficiency. For example, this may include correcting the accessibility deficiency associated with a caption for an icon that is in a font that is too small for a nearsighted user. In another example, this may include correcting the accessibility deficiency associated with a caption for an icon that is in a color that does not work for certain types of colorblindness, such as green text for a red/green colorblindness user. In another example, this may include correcting the accessibility deficiency associated with amplifying the sound of a notification for an error message for a hearing-limited user. In another example, this may include correcting the accessibility deficiency associated with requesting alternative haptic input or feedback if the initially requested haptic input or feedback is insufficient or inapplicable for a user having physical disabilities. In this example, this may comprise requesting hand palm pressing instead of fingerprint pressing. In another example, this may include correcting the accessibility deficiency associated with requesting audible haptic input or alternative haptic input associated with Braille for a blind user attempting to provide a credit card number, name, expiration date, and/or card verification value.

Alternatively or additionally, the test engine may be configured to generate and provide one or more suggestions, such as a prediction or recommendation, for correcting the one or more accessibility deficiencies. The high or low impact change may be restricted to recommendations, but the latter high or low impact change may be permitted for implementation instead of recommendations.

In another example, the test engine may be configured to implement one or more changes to the development application within desired functions or desired areas of changes. For example, the font size and/or color may be sufficient but rearrangement of the icons may be restricted to recommendations, such as missing using animations on error messages. Alternatively or additionally, the one or more changes to legacy features of a native mobile application may be proper for the test engine to change whereas new features of the native mobile application and/or authorized access, such as developers associated with the native mobile application, may desire more or less control of the new features of the native mobile application.

At block 425, the method 400 may include transmitting a request for user approval prior to implementing the change upon determining that the change is a high impact change. For example, the test engine may be configured to transmit one or more requests requiring input of user approval prior to implementing the change to the development application, the changing comprising a high impact change. The input may be authenticated by the test engine. Without limitation, the input associated with user approval may comprise at least one selected from the group of a username, a password, a one-time passcode, a mobile device number, a birthdate, a response to a knowledge-based authentication question, an account number, a transaction number, a biometric (e.g., facial scan, a retina scan, a fingerprint, and a voice input for voice recognition), and/or any combination thereof. It is further understood that partial input, such as last four digits of an identification number or redaction of any input, may be authenticated and deemed sufficient as forming a response to the request regarding user approval. Moreover, the request for user approval may be adjusted to reflect and/or account for any number of deficiencies or disabilities associated with a type of impairment associated with the user. For example, if the user is deaf or hearing impaired, the test engine may be configured to transmit a request for a certain type of haptic feedback input. In another example, if the user is blind or visually impaired, the test engine may be configured to transmit a request for a certain but different type of haptic feedback input. Without limitation, the user approval may be transmitted from, and received by the test engine, an application comprising instructions for execution on a client device, any haptic feedback input device, and/or any combination thereof. It is understood that block 425 may be optional in view of block 420 in some examples.

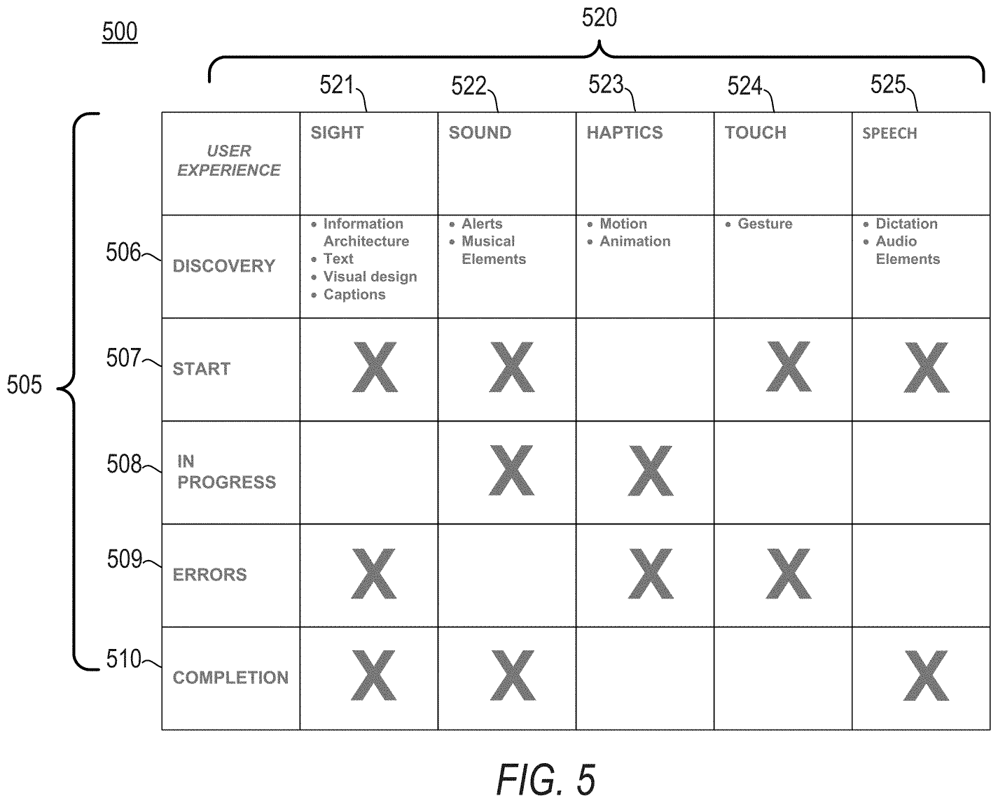

FIG. 5 illustrates an accessibility matrix 500. The accessibility matrix may comprises a one or more rows 505 and a one or more columns 520.

The one or more rows 505 may represent one or more user experiences occurring as a user interactions with a development application. As shown in FIG. 5, the one or more rows 505 may include row 506, row 507, row 508, row 509, and row 510. Row 506 may represent the user's discovery process during an initial engagement with the development application. For example, this may include the user such as first opening the development application and initial viewing of the development application's interfaces. Row 507 may represent the user starting to interact with the development application. For example, this may include initiating execution of the development application (e.g., opening the application), ascertaining what functionality of the development application to use, providing initial commands, and performing initial operations. Row 508 may represent an in progress user interaction with the development application. For example, this may include using functionality of the development application, providing commands, and performing operations. Row 509 may represent one or more errors occurring during the user's interaction with the development application. For example, this may include errors occurring in connection with the use of the functionality of the development application, with providing commands, with performing operations, and may also include errors caused by accessibility problems and shortcomings, user errors, and software bugs. Row 510 may represent completion of the user's session with the development application, including final uses of development application functionality, providing final commands, performing final operations, and ending execution of the development application (e.g., closing the application).

The one or more columns 520 may represent the senses through which the user perceives and interacts with the development application. As shown in FIG. 5, the one or more columns 520 may include column 521, column 522, column 523, column 524, and column 525. Column 521 may represent the user's sight and visual engagement with the development application. For example, this may include the user's visual perception of the development application's interfaces, such as its text, captions, and visual designs, visual inputs provided by the user, and the development application's information architecture and visual presentation of information. Column 522 may represent the user's hearing and audio engagement with the development application. For example, this may include the user's audio perception of the development application's interfaces, such as sounds generated by the development application (e.g., alerts, dings, chimes), music played by the development application, audio inputs provided by the user, and the development application's audible presentation of information. Column 523 may represent the user's experience with haptics and haptic feedback from the development application. For example, this may include the development application's delivery of haptic feedback and user's perception of haptics in relation the development application. Column 524 may represent the user's tactile perception and engagement with the development application, such as through input devices (e.g., a mouse, a touchscreen, a keyboard, soft buttons, gestures) and output devices (e.g., a display screen, vibrational outputs). For example, this may include the user's use of input devices and output devices. Column 525 may represent user's experience in engaging with the development application via speech, including dictation, audio elements, and voice inputs. For example, this may include the user dictating text, providing voice commands, receiving audio feedback, and interacting with audio elements of the development application interface.

The one or more rows 505 and the one or more columns 520 may provide accessibility guidance, requirements, and other considerations. The intersection of each row and column can identify particular accessibility guidance, requirements, or other considerations for this aspect, and may further specify a satisfactory or unsatisfactory accessibility outcome for that aspect. The accessibility matrix may be incorporated into the automated testing systems and methods described herein.

The accessibility matrix 500 illustrated in FIG. 5 is exemplary, and the present disclosure is not limited to this example. It is understood that the present disclosure includes any accessibility matrix and/or other accessibility guidance, requirements, or other considerations, presented in the same or different formats.

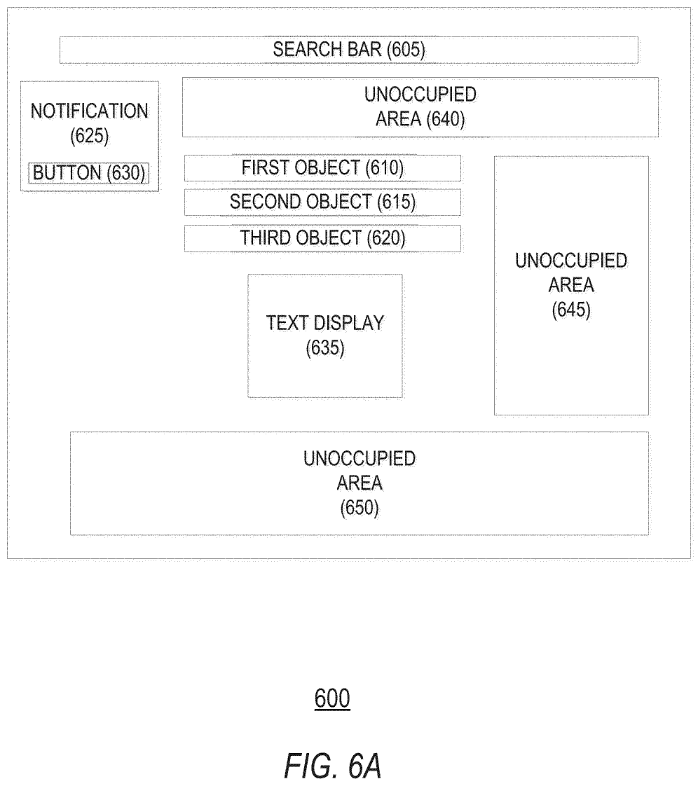

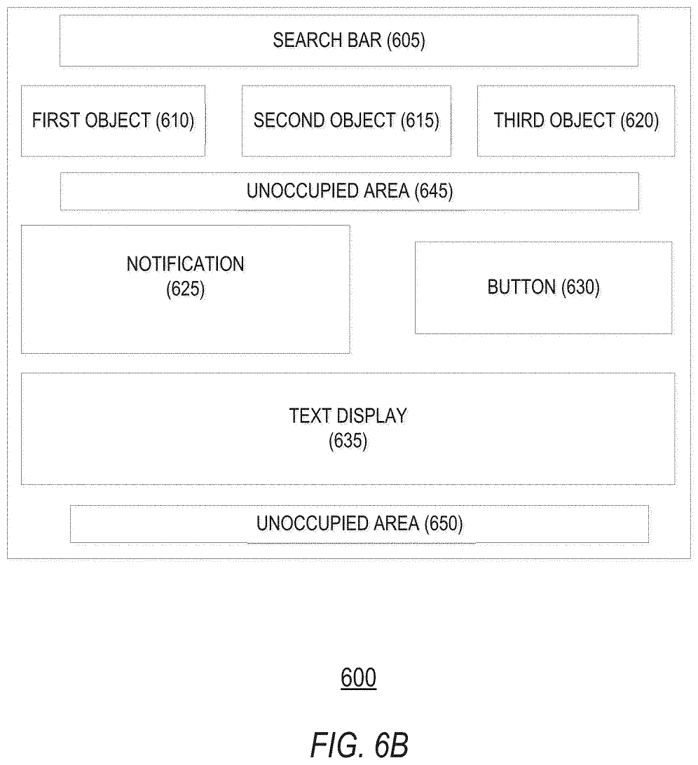

FIGS. 6A and 6B illustrate a graphical user interface 600 of a development application subjected to automated testing. FIG. 6A illustrates the graphical user interface 600 prior to undergoing automated testing, and FIG. 6B illustrate the graphical user interface 600 after undergoing automated testing.

As shown in FIG. 6A, the graphical user interface 600 may include a plurality interface elements. For example, the graphical user interface 600 may include search bar 605, first object 610, second object 615, third object 620, notification 625, button 630, text display 635, and unoccupied areas 640, 645, 650. The search bar 605 can receive user input via an input device for executing a search. First object 610, second object 615, and third object 620, may be icons, images, links, drop-down menus, text, or other items that the user may view and interact with. Notification 625 may be a displayed alert, pop-up, or other message presented by the graphical user interface 600, and button 630 may be a button that can be clicked by the user to cause the development application to perform an action. Button 630 can be associated with and displayed within notification 625. Text display 635 may be a display of text, images, animations, or other information for viewing by the user. Unoccupied areas 640, 645, 650 may represent empty or otherwise unused areas of the graphical user interface 600.

FIG. 6A shows that the search bar 605 is placed near the top of the graphical user interface 600, with the notification 625, button 630, and unoccupied area 640 located below it. First object 610, second object 615, third object 620, and text display 635 are located adjacent to each other in a vertical arrangement. Unoccupied area 645 and unoccupied area 650 are located around the vertical arrangement of these elements.

The exemplary collection of elements and their arrangement in FIG. 6A is prior to the automated testing. Automated testing according to the systems and methods described herein may be performed graphical user interface 600 as illustrated in FIG. 6A, and the results of the automated testing are illustrated in FIG. 6B.

As shown in FIG. 6B, the graphical user interface 600 may include search bar 605, first object 610, second object 615, third object 620, notification 625, button 630, text display 635, and unoccupied areas 645, 650, and unoccupied area 640 has been removed, as a result of the automated testing. In FIG. 6B, the search bar 605, first object 610, second object 615, third object 620, notification 625, button 630, and text display 635 have been enlarged. The locations of the elements have also be changed. For example, first object 610, second object 615, and third object 620 have been moved to a horizontal arrangement below search bar 605 in order to more easily viewed and/or clicked by the user. Notification 625 and button 630 have been changed to a horizontal alignment and button 630 no longer appears within notification 625. The text display 635 has been expanded covers most of the width of the graphical user interface 600. To create space for these adjustments, unoccupied area 640 has been removed and unoccupied area 645 has been reduced in size and adjusted to a different orientation within the interface. These changes may provide improved visibility and make it easier for a user to interact with (e.g., view, click, select, enter text) these elements. These changes may reduce mistakes made by the user, such as mis-clicks or failure to notice or understand elements, and make the functionality presented by the graphical user interface more accessible to the user. These changes may be made using an accessibility matrix or other accessibility guidelines. It is understood that these changes are exemplary and non-limiting, and that other accessibility changes may be implemented.

In some examples, the font size of text contained in the elements can be increased and the font used may be changed to a font with improved contrast and visibility. Also, one or more elements may be removed from one interface and added to another in order to provide additional space or create a cleaner interface with reduced clutter. Audio or haptic feedback may be added to the graphical user interface 600, along with the ability to accept voice inputs. Accordingly, the graphical user interface 600 as shown in FIG. 6B demonstrates improved accessibility as a result of the automated testing.

In some examples, the test engine may identify one or more of the foregoing changes as suggestions or proposed changes for review. In other examples, the test engine may implement one or more of the foregoing changes automatically, without review. As described herein, the changes may be scored and compared a threshold to determine whether the changes are directly implemented or subject to review.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. An automated testing system, comprising:
a server comprising a processor and a memory, the memory containing an accessibility matrix; and
a test engine in data communication with the server, the test engine comprising a machine learning model,
wherein, upon receipt of a development application comprising one or more functions, the test engine is configured to:
generate a test script configured to test at least one of the one or more functions,
execute the test script to generate a test result, and
implement a change to the development application based on the test result and the accessibility matrix.

2. The automated testing system of claim 1, wherein, prior to implementing the change, the test engine is configured to:
identify the change by comparing the test result to the accessibility matrix, and
classify the change in at least one selected from the group of an appearance change category and a functionality change category.

3. The automated testing system of claim 2, wherein the appearance change comprises at least one selected from the group of a font size change, a font color change, and a color contrast change.

4. The automated testing system of claim 3, wherein the appearance change is selected to address a type of color blindness.

5. The automated testing system of claim 4, wherein the functionality change comprises at least one selected from the group of adding a user interface element, removing a user interface element, increasing a spacing between a plurality of user interface elements, decreasing a spacing between a plurality of user interface elements, adding a feedback, and removing a feedback.

6. The automated testing system of claim 5, wherein the feedback comprises at least one selected from the group of a visual notification, an audio notification, an animation notification, and a haptic notification.

7. The automated testing system of claim 2, wherein, upon classifying the change in the functionality change category, the test engine is further configured to request user approval prior to implementing the change.

8. The automated testing system of claim 1, wherein the machine learning model is trained on a dataset comprising a plurality of case studies.

9. The automated testing system of claim 8, wherein the plurality of case studies comprise case study applications including one or more accessibility deficiencies and one or more accessibility deficiency corrections.

10. The automated testing system of claim 9, wherein the one or more accessibility deficiencies and one or more accessibility deficiency corrections comply with the accessibility matrix.

11. The automated testing system of claim 8, wherein the plurality of case studies comprise case study applications that comply with the accessibility matrix.

12. The automated testing system of claim 1, wherein the memory contains a library configured to:
provide a accessibility matrix interface, and
provide an evaluation report interface.

13. An automated testing method, comprising:
providing a development application;
generating, by a test engine, a test script, wherein the test engine comprises a machine learning model trained on a training dataset comprising a plurality of case studies;
executing, by the test engine, the test script;
generating, by the test script, a test result;
identifying, by the test engine, a change to the development application by comparing the test result and accessibility matrix; and
implementing, by the test engine, the change to the development application.

14. The automated testing method of claim 13, further comprising:
generating, by the test engine, an evaluation report interface; and
displaying, by the test engine, the test result within the evaluation report interface.

15. The automated testing method of claim 13, further comprising, prior to implementing the change:
classifying the change as a high impact change or a low impact change; and
upon determining that the change is a low impact change, implementing the change.

16. The automated testing method of claim 13, further comprising, prior to implementing the change:
classifying the change as a high impact change or a low impact change; and
upon determining that the change is a high impact change, transmitting a request for user approval prior to implementing the change.

17. The automated testing method of claim 13, further comprising assigning a score to the change.

18. The automated testing method of claim 17, further comprising:
comparing the score to a threshold; and
implementing the change if the score exceeds the threshold.

19. The automated testing method of claim 13, wherein the plurality of case studies includes one or more case study applications that comply with the accessibility matrix.

20. A non-transitory computer-accessible medium having stored thereon computer-executable instructions for automated testing, wherein, when a computer arrangement executes the instructions, the computer arrangement is configured to perform procedures comprising:
training a test engine comprising a machine learning model on a plurality of case studies;
generating a test script for a development application;
executing the test script to generate a test result;
comparing the test result to an accessibility matrix;
identifying a change to the development application based on the comparison;
assigning a score to the change;
comparing the score to a threshold; and
upon determining that the score exceeds the threshold, implementing the change to the development application.
